(19) United States
(12) Patent Application Publication
(10) Pub. No.: US 2024/0377529 A1
(43) Pub. Date: Nov. 14, 2024

(54) VEHICLE AND A METHOD OF CONTROLLING THE SAME

(71) Applicants: HYUNDAI MOTOR COMPANY, Seoul (KR); KIA CORPORATION, Seoul (KR)

(72) Inventor: Jihyun Lim, Suwon-si (KR)

(73) Assignees: HYUNDAI MOTOR COMPANY, Seoul (KR); KIA CORPORATION, Seoul (KR)

(21) Appl. No.: 18/603,565

(22) Filed: Mar. 13, 2024

(30) Foreign Application Priority Data
May 8, 2023 (KR) 10-2023-0058863

(51) Int. Cl. G01S 13/931; G01S 13/87

(52) U.S. Cl. CPC G01S 13/931; G01S 13/878

(57) ABSTRACT

A vehicle includes one or more radars configured to transmit a radar wave and receive a first radar wave reflected back from a surrounding vehicle. to the one or more radars are also configured to receive a second radar wave transmitted from the surrounding vehicle The vehicle further includes a controller configured to detect the surrounding vehicle using the first radar wave and the second radar wave received from the one or more radars.

### CROSS-REFERENCE TO RELATED APPLICATION

This application claims the benefit of and priority to Korean Patent Application No. 10-2023-0058863, filed on May 8, 2023, the entire contents of which are incorporated herein by reference.

### TECHNICAL FIELD

The present disclosure relates to a vehicle and a method of controlling the same, and more particularly, to a vehicle capable of recognizing a location of another vehicle.

### BACKGROUND

The statements in this section merely provide background information related to the present disclosure and may not constitute prior art.

In general, an advanced driver assistance system (ADAS) is a system that helps a driver drive a vehicle safely. The ADAS includes a variety of technologies designed to improve driving safety, user comfort, and efficiency.

The ADAS typically uses sensors, such as radar, light detection and ranging (LiDAR), and cameras to detect a vehicle's surroundings, and processes data obtained from the sensors to send a warning to a driver or automatically adjust the vehicle. For example, ADAS may include a lane departure warning system (LDWS), an automatic emergency braking (AEB), an adaptive cruise control (ACC), a rear cross traffic alert (RCTA), and a lane keeping assist system (LKAS), and may use other technologies, such as a forward collision avoidance (FCA), a blind spot collision avoidance (BCA), a smart cruise control (SCC), a rear cross traffic collision avoidance (RCCA), or the like.

However, if such ADAS is not able to accurately detect a surrounding vehicle, it is difficult to prevent accidents.

### SUMMARY

An aspect of the present disclosure provides a vehicle capable of recognizing a surrounding vehicle using radar waves transmitted from the surrounding vehicle.

Additional aspects of the present disclosure are set forth in part in the description which follows and, in part, should be understood from the description, or may be learned by practice of the present disclosure.

In accordance with an embodiment of the present disclosure, a vehicle is provided. The vehicle includes at least one radar configured to transmit a radar wave and receive a first radar wave reflected back from a surrounding vehicle. The at least one radar is also configured to receive a second radar wave transmitted from the surrounding vehicle. The vehicle also includes a controller configured to detect the surrounding vehicle using the first radar wave and the second radar wave received from the at least one radar.

The controller may be configured to recognize the surrounding vehicle by merging the first radar wave and the second radar wave.

The controller may be configured to distinguish between the first radar wave and the second radar wave based on frequency.

The controller may be configured to recognize the surrounding vehicle using information on a location and speed of the surrounding vehicle.

The at least one radar may include a plurality of radars. The plurality of radars may be configured to receive one or both of the first radar wave and the second radar wave at different angular ranges.

The controller may be configured to control the plurality of radars to operate sequentially.

The vehicle may further include a map storage unit including location information and map information.

The controller may be configured to determine whether the vehicle is about to collide with the surrounding vehicle using the location information and the map information from the map storage unit and information on the recognized surrounding vehicle.

In accordance with another embodiment of the present disclosure, a method of controlling a vehicle is provided. The method includes transmitting, by at least one radar, a radar wave and receiving a first radar wave reflected back from a surrounding vehicle. The method also includes receiving, by the at least one radar, a second radar wave transmitted from the surrounding vehicle. The method further includes recognizing, by a controller, the surrounding vehicle using the first radar wave and the second radar wave received from the at least one radar.

Recognizing the surrounding vehicle may include recognizing the surrounding vehicle by merging the first radar wave and the second radar wave.

The method may further include distinguishing, by the controller, between the first radar wave and the second radar wave based on frequency.

Recognizing the surrounding vehicle may include recognizing the surrounding vehicle using information on a location and speed of the surrounding vehicle.

The at least one radar may include a plurality of radars. Receiving one or both of the first radar wave and the second radar wave may include receiving the one or both of the first radar wave and the second radar wave by the plurality of radars at different angular ranges.

The method may further include controlling, by the controller, the plurality of radars to operate sequentially.

The method may further include: determining, by the controller, whether the vehicle is about to collide with the surrounding vehicle using location information and map information from a map storage unit and the map information and information on the recognized surrounding vehicle.

### BRIEF DESCRIPTION OF THE DRAWINGS

These and/or other aspects of embodiments of the present disclosure should be apparent and more readily appreciated from the following description of the embodiments, taken in conjunction with the accompanying drawings, in which:

FIG. 1 is a block diagram illustrating a recognition device, according to an embodiment of the present disclosure;

FIG. 2 is a view illustrating a use of a radar installed in a host vehicle to recognize a surrounding vehicle, according to an embodiment of the present disclosure;

FIG. 3 is a graph to explain the distinction between radio waves transmitted from the host vehicle and radio waves transmitted from the surrounding vehicle, according to an embodiment of the present disclosure;

FIG. 4 is a view illustrating an example of recognizing the surrounding vehicle at an intersection by receiving radar waves transmitted from the surrounding vehicle by the host vehicle using the recognition device, according to an embodiment of the present disclosure;

FIG. 5 is a view illustrating an example of recognizing the surrounding vehicle in an inclined parking lot by receiving radar waves transmitted from the surrounding vehicle by the host vehicle using the recognition device, according to an embodiment of the present disclosure;

FIG. 6 is a view illustrating an example of recognizing the surrounding vehicle on a road with a large gradient by receiving radar waves transmitted from the surrounding vehicle using the recognition device, according to an embodiment of the present disclosure;

FIG. 7 is a view illustrating an example of recognizing the surrounding vehicle on a road with a large gradient by receiving radar waves transmitted from the surrounding vehicle using the recognition device, according to an embodiment of the present disclosure; and

FIG. 8 is a flowchart illustrating a method of recognizing the surrounding vehicle using the recognition device, according to an embodiment of the present disclosure.

### DETAILED DESCRIPTION

The following description is merely illustrative in nature and is not intended to limit the present disclosure, application, or uses. It should be understood that throughout the drawings, corresponding reference numerals indicate like or corresponding parts and features.

Reference is made below in detail to the embodiments of the present disclosure, examples of which are illustrated in the accompanying drawings. The present disclosure does not necessarily describe all elements of the disclosed embodiments. Detailed descriptions of what is well known in the art or redundant descriptions of substantially the same configurations may have been omitted. The terms ‘part’, ‘unit’ ‘module’, ‘member’, ‘block’ and the like as used in the present disclosure may be implemented in software or hardware. Further, a plurality of ‘parts’, ‘modules’, ‘members’, ‘units’, ‘blocks’ and the like may be embodied as one component. It is also possible that one ‘part’, ‘module’, ‘member’, ‘unit’, ‘block’ and the like includes a plurality of components.

Throughout the present disclosure, when an element is referred to as being “connected to” another element, it may be directly or indirectly connected to the other element and the “indirectly connected to” includes being connected to the other element via a wireless communication network.

Also, it should be understood that the terms “include” and “have” are intended to indicate the existence of elements disclosed in the present disclosure, and are not intended to preclude the possibility that one or more other elements may exist or may be added.

Throughout the present disclosure, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations. The operations may be performed in a different order unless otherwise stated.

When a component, device, element, or the like of the present disclosure is described as having a purpose or performing an operation, function, or the like, the component, device, or element should be considered herein as being “configured to” meet that purpose or to perform that operation or function.

Hereinafter, embodiments of the present disclosure are described in detail with reference to the accompanying drawings.

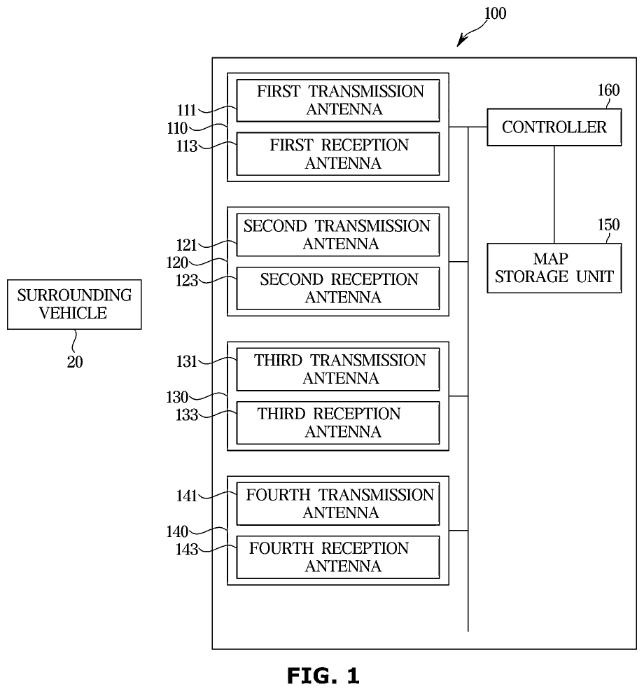

With reference to FIGS. 1-7, a vehicle recognition device 100 according to an embodiment of the present disclosure is described. The vehicle recognition device 100 is a device for a host vehicle 10 to recognize a surrounding vehicle. The recognition device 100 may be included in the host vehicle 10.

The recognition device 100 may include a first radar 110, a second radar 120, a third radar 130, a fourth radar 140, a map storage unit 150, and a controller 160.

The first radar 110 may be installed in the host vehicle 10. The first radar 110 may be positioned at a left front of the host vehicle 10 with respect to a driver. The first radar 110 may include a first transmission antenna 111 and a first reception antenna 113.

The first transmission antenna 111 may transmit radar waves generated by the first radar 110 to the outside. The first reception antenna 113 may receive radar waves generated by the first radar 110 and reflected back from the outside. Additionally, in one embodiment, the first reception antenna 113 may receive radar waves received from the outside (e.g., from a surrounding vehicle).

The second radar 120 may be installed in the host vehicle 10. The second radar 120 may be positioned at a right front of the host vehicle 10 with respect to the driver. The second radar 120 may include a second transmission antenna 121 and a second reception antenna 123.

The second transmission antenna 121 may transmit radar waves generated by the second radar 120 to the outside. The second reception antenna 123 may receive radar waves generated by the second radar 120 and reflected back from the outside. In addition, in one embodiment, the second reception antenna 123 may receive radar waves received from the outside (e.g., from the surrounding vehicle).

The third radar 130 may be installed in the host vehicle 10. The third radar may be positioned at a right rear of the host vehicle 10 with respect to the driver. The third radar 130 may include a third transmission antenna 131 and a third reception antenna 133.

The third transmission antenna 131 may transmit radar waves generated by the third radar 130 to the outside. The third reception antenna 133 may receive radar waves generated by the third radar 130 and reflected back from the outside. Additionally, in one embodiment, the third reception antenna 133 may receive radar waves received from the outside (e.g., from the surrounding vehicle).

The fourth radar 140 may be installed in the host vehicle 10. The fourth radar 140 may be positioned at a left rear of the host vehicle 10 with respect to the driver. The fourth radar 140 may include a fourth transmission antenna 141 and a fourth reception antenna 143.

The fourth transmission antenna 141 may transmit radar waves generated by the fourth radar 140 to the outside. The fourth reception antenna 143 may receive radar waves generated by the fourth radar 140 and reflected back from the outside. Additionally, in one embodiment, the fourth reception antenna 143 may receive radar waves received from the outside (e.g., from the surrounding vehicle).

The first radar 110, the second radar 120, the third radar 130, and the fourth radar 140 as described above may each transmit radar waves to the outside in a predetermined angle range, and may each receive radar waves in a predetermined angle range. Accordingly, the first radar 110, the second radar 120, the third radar 130, and the fourth radar 140 may be arranged to have angular coverage in different directions. Here, as needed, the first radar 110, the second radar 120, the third radar 130, and the fourth radar 140 may each have an angular range for transmitting radar waves that is wider than an angular range for receiving radar waves.

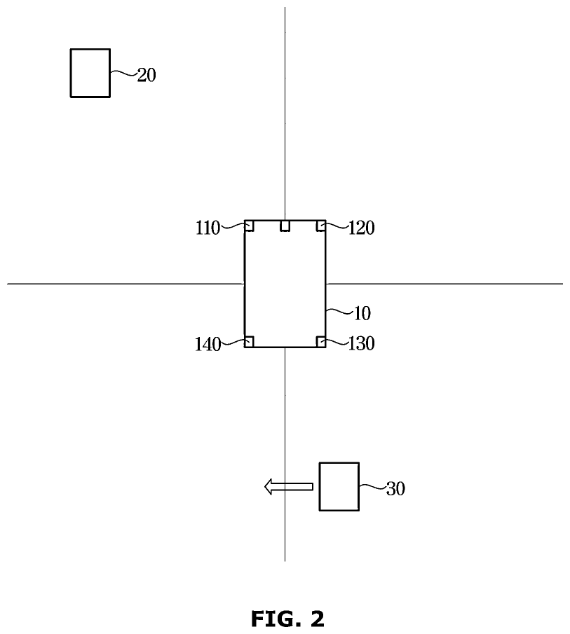

Referring to FIG. 2, with the first radar 110, the second radar 120, the third radar 130, and the fourth radar 140 installed in the host vehicle 10, the first radar 110 may detect the left front with respect to the host vehicle 10, the second radar 120 may detect the right front with respect to the host vehicle 10, the third radar 130 may detect the right rear with respect to the host vehicle 10, and the fourth radar 140 may detect the left rear with respect to the host vehicle 10. The first radar 110, the second radar 120, the third radar 130, and the fourth radar 140 are arranged to detect different directions, so that a location of surrounding vehicles (or other vehicles) positioned around the host vehicle 10 may be easily identified.

The map storage unit 150 may be installed in the host vehicle 10. The map storage unit 150 may store information about the map. In addition, the map storage unit 150 may receive the location of the host vehicle 10 from a navigation satellite. Accordingly, the map storage unit 150 may identify map information on the surroundings of the location of the host vehicle 10.

The controller 160 may receive signals from the first radar 110, the second radar 120, the third radar 130, and the fourth radar 140 relating to radio waves detected by the first radar 110, the second radar 120, the third radar 130, and the fourth radar 140, respectively. The controller 160 may receive location information of the host vehicle 10 and surrounding map information from the map storage unit 150.

Furthermore, the controller 160 may control the first radar 110, the second radar 120, the third radar 130, the fourth radar 140, and the map storage unit 150, respectively.

In one embodiment, when the controller 160 controls the first radar 110, the second radar 120, the third radar 130, and the fourth radar 140, each radar may be divided into zones to receive radar waves, as shown in FIG. 2, and may be controlled to receive signals from radar waves transmitted by surrounding vehicles in the order of the first radar 110, the second radar 120, the third radar 130, and the fourth radar 140.

To more specifically identify the location of surrounding vehicles, the controller 160 may use a triangulation method, such as by using the strength of radar waves received from each radar or the phase angle of the radar waves. For example, referring to FIG. 2, for a first surrounding vehicle 20, the first radar 110 of the four radars has a higher signal strength of radar waves, so the controller 160 may identify that the first surrounding vehicle 20 is located to the left front of the vehicle 10.

Furthermore, the controller 160 may generate an object by receiving signals of radar waves received from the surrounding vehicles from each radar. The controller 160 may also identify changes in a speed and position of the surrounding vehicles through an amount of change in the strengthen of radar waves. For example, referring to FIG. 2, when a second surrounding vehicle 30 is located behind the host vehicle 10 and is moving from right to left, the controller 160 may identify that the second surrounding vehicle 30 is moving by continuously identifying the signal strengths of radar waves received from the third radar 130 and the fourth radar 140.

In one embodiment, the first radar 110, the second radar 120, the third radar 130, and the fourth radar 140 is each installed in the host vehicle 10, but the present disclosure is not limited thereto. The number of radars installed in the host vehicle 10 may vary, and the reception angle range of radar waves detected by each radar may also vary as needed.

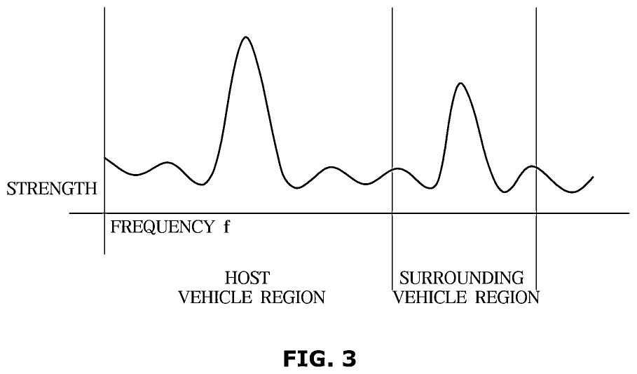

As described above, the controller 160 may identify the location of the object based on signals received from radar waves transmitted from each radar and reflected back to the object. In addition, in one embodiment, each radar may receive radar waves transmitted from the surrounding vehicles. As shown in FIG. 3, the controller 160 may distinguish between signals received from radar waves transmitted by each radar and radar waves received from the surrounding vehicle.

For example, the controller 160 may represent the strength of the received radar waves by performing Fast Fourier Transform (FFT) on the signals of the radar wave received from each radar. Accordingly, the controller 160 may differentiate based on the fact that the radar wave transmitted from the radar installed in the host vehicle 10 is received first, and then the radar wave transmitted from the surrounding vehicle is received later. In other words, The controller (160) may differentiate based on the sequence of receiving radar waves.

The controller 160 may thus recognize in advance an area for the received radar wave through FFT, and thus may identify that the radar wave with a strength higher than a predetermined value received thereafter is received from surrounding vehicle.

The controller 160 may use radar waves received from each radar of the host vehicle 10 and radar waves received from surrounding vehicles to collect information about the surroundings of the host vehicle 10, to recognize the collected information as final information, and to manage the information as one object.

Such managed objects may then be used by the controller 160 for autonomous driving scenarios using map information stored in the map storage unit 150.

For example, the controller 160 may use the managed objects for Forward Collision Avoidance (FCA), Blind Spot Collision Avoidance (BCA), Smart Cruise Control (SCC), and/or Rear Cross Traffic Collision Avoidance (RCCA). FCA is a system that prevents accidents in autonomous driving by sending a warning to a driver or automatically applying brakes when there is a risk of collision ahead. BCA is a system that prevents accidents in autonomous driving by detecting a location of a surrounding vehicle in sections where rear visibility is difficult and sending a warning to a driver or automatically applying brakes. SCC is a system in which the vehicle automatically detects a speed and distance of the vehicle ahead and automatically adjusts the speed without driver intervention. RCCA is a system that detects vehicles approaching from the rear of a parked vehicle and sends a warning to a driver or automatically applies brakes to prevent accidents.

The controller 160 may be implemented by a computing device including a microprocessor, a memory, etc. As various implementations of the controller 160 should be apparent to those having ordinary skill in the art, further detailed description has been omitted.

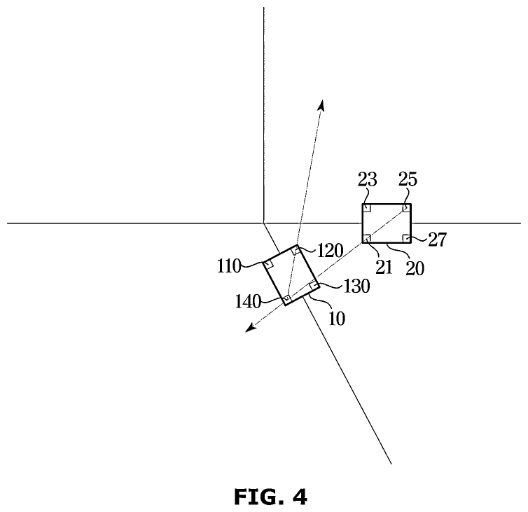

An example in which the host vehicle 10 identifies the location of the first surrounding vehicle 20 positioned nearby, according to an embodiment, is described in more detail below with reference to FIGS. 4-7.

Referring to FIG. 4, at an intersection, when the host vehicle 10 and the first surrounding vehicle 20 move towards the intersection on different roads, the host vehicle 10 may perform collision warning or collision assistance with the first surrounding vehicle 20, for example, by using Forward Collision Avoidance-Junction Crossing (FCA-JC) including respective radars and cameras installed in the host vehicle 10. The host vehicle 10 may not be able to recognize the first surrounding vehicle 20 depending on an angle range for recognizing obstacles in a vicinity. However, as in one embodiment of the present disclosure, upon receipt of the radar wave transmitted from the first surrounding vehicle 20, the host vehicle 10 may increase a rate at which the host vehicle 10 recognizes the first surrounding vehicle 20.

In one embodiment, the first surrounding vehicle 20 may include a first other radar 21, a second other radar 23, a third other radar 25, and a fourth other radar 27, as shown in the accompanying drawings. The first surrounding vehicle 20, like the host vehicle 10, may transmit radar waves to identify other surrounding vehicles through the other radars 21, 23, 25, and 27, respectively.

As such, at least one of the first radar 110, the second radar 120, the third radar 130, and the fourth radar 140 of the host vehicle 10 may receive the radar wave transmitted from the first surrounding vehicle 20.

In addition, when recognizing the location of the first surrounding vehicle 20, the controller 160 may receive radar waves transmitted from the first surrounding vehicle 20 according to the frequency, and may calculate the amount of change based on the location according to the reception intensity of the radar waves received from the second radar 120 and the third radar 130. Thus the, controller 160 may calculate the location and speed of the first surrounding vehicle 20. Furthermore, the controller 160 may correct the calculated position and speed of the first surrounding vehicle 20 with the map information obtained through the map storage unit 150 to detect whether they are about to collide at an intersection, thereby performing collision warning and assistance with the first surrounding vehicle 20.

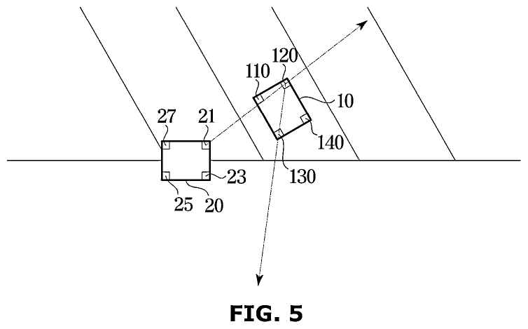

Furthermore, referring to FIG. 5, when parking at an angle, unlike the case of parking the host vehicle 10 at a right angle, it may occur that the host vehicle 10 does not recognize the first surrounding vehicle 20. In one embodiment, as the host vehicle 10 receives the radar wave transmitted from the first surrounding vehicle 20, the host vehicle 10 may clearly recognize the first surrounding vehicle 20 even though each radar of the host vehicle 10 does not recognize the first surrounding vehicle 20.

For example, the radar wave transmitted from the host vehicle 10 may not reach the first surrounding vehicle 20, and thus may not allow the first surrounding vehicle 20 to be recognized by the radar wave transmitted from the host vehicle 10. However, the radar wave transmitted from the first surrounding vehicle 20 may be received by the host vehicle 10, and thus the host vehicle 10 may recognize the first surrounding vehicle 20.

Accordingly, by receiving the radar waves of the first surrounding vehicle 20 received from the first radar 110 and the fourth radar 140 of the host vehicle 10 and calculating the amount of change based on the location according to the reception strength, the controller 160 may estimate the location and speed of the first surrounding vehicle 20.

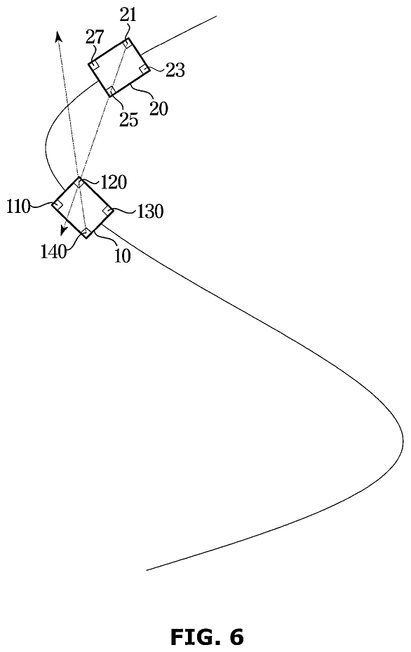

Referring to FIG. 6, when the host vehicle 10 and the first surrounding vehicle 20 are traveling on a road with a large gradient and the first surrounding vehicle 20 is ahead of the host vehicle 10, it may occur that the host vehicle 10 does not recognize the first surrounding vehicle 20 due to the gradient of the road. In this case, if the speed of the first surrounding vehicle 20 is relatively slower than the speed of the host vehicle 10, the host vehicle 10 may collide with the first surrounding vehicle 20. In one embodiment, the host vehicle 10 may clearly recognize the first surrounding vehicle 20 by receiving the radar wave transmitted from the first surrounding vehicle 20.

For example, the radar wave transmitted from the host vehicle 10 may not reach the first surrounding vehicle 20, and thus may not allow the first surrounding vehicle 20 to be recognized by the radar wave transmitted from the host vehicle 10. However, the radar wave transmitted from the surrounding vehicle 20 may be received by the host vehicle 10, and thus the host vehicle 10 may recognize the first surrounding vehicle 20.

Accordingly, by receiving the radar waves of the first surrounding vehicle 20 received from the second radar 120 and the third radar 130 of the host vehicle 10 and calculating the amount of change in consideration of the location according to the reception strength, the controller 160 may estimate the location and speed of the first surrounding vehicle 20.

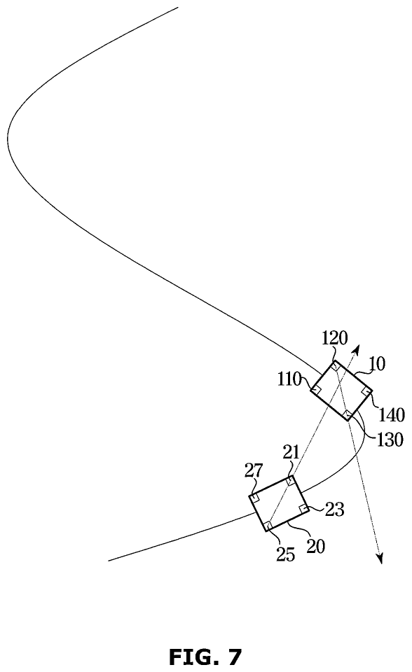

Referring to FIG. 7, when the host vehicle 10 and the first surrounding vehicle 20 are travelling on a road with a large gradient and the host vehicle 10 is ahead of the first surrounding vehicle 20, it may occur that the host vehicle 10 does not recognize the first surrounding vehicle 20 due to the gradient of the road. In this case, if the speed of the first surrounding vehicle 20 is relatively faster than that of the host vehicle 10, the first surrounding vehicle 20 may collide with the host vehicle 10. In one embodiment, the host vehicle 10 may clearly recognize the first surrounding vehicle 20 by receiving the radar wave transmitted from the first surrounding vehicle 20.

For example, the radar wave transmitted from the host vehicle 10 may not reach the first surrounding vehicle 20, and thus may not allow the first surrounding vehicle 20 to be recognized by the radar wave transmitted from the host vehicle 10. However, the radar waves transmitted from the surrounding vehicle 20 is received by the host vehicle 10, and thus the host vehicle 10 may recognize the first surrounding vehicle 20.

Accordingly, by receiving the radar waves of the first surrounding vehicle 20 received from the first radar 110 and the third radar 130 of the host vehicle 10 and calculating the amount of change based on the location according to the reception strength, the controller 160 may estimate the location and speed of the first surrounding vehicle 20.

Various examples in which the host vehicle 10 may clearly recognize the first surrounding vehicle 20 have been described above with reference to FIGS. 4-7. However, the present disclosure is not limited by the described examples. In different examples not described, even if there is a case where the first surrounding vehicle 20 is not recognized through each radar installed in the host vehicle 10, the host vehicle 10 may clearly recognize the first surrounding vehicle 20 by receiving the radar wave transmitted from the first surrounding vehicle 20.

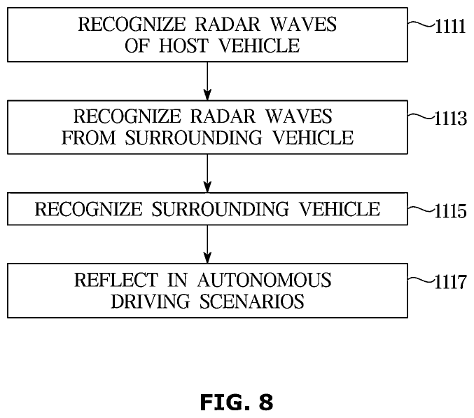

Referring now to FIG. 8, a method for a vehicle to recognize the surrounding vehicle using the recognition device 100 according to an embodiment of the present disclosure is described. The method may be performed by the controller 160, for example.

In an operation 1111, the controller 160 may recognize radar waves of the host vehicle 10.

The controller 160 may receive and recognize the radar waves transmitted from the radars of the host vehicle 10 and reflected back from the surrounding vehicle through the respective radars installed on the host vehicle 10. To this end, the controller 160 may perform the FFT on the signals to the radar waves received from the first radar 110, the second radar 120, the third radar 130, and the fourth radar 140 and recognize through the strength of the radar waves.

In an operation 1113, the controller 160 may recognize the radar waves from the surrounding vehicle.

The controller 160 may receive and recognize the radar waves transmitted from the surrounding vehicle through each radar installed in the host vehicle 10. To this end, the controller 160 may perform the FFT on the signals to the radar waves of the surrounding vehicle received from the first radar 110, the second radar 120, the third radar 130, and the fourth radar 140 and recognize through the strength of the radar waves.

The controller 160 may distinguish between the radar waves transmitted and returned from the host vehicle 10 and the radar waves transmitted from the surrounding vehicles by dividing the radar waves into regions. For example, as shown in FIG. 2, the controller 160 may distinguish between the radar waves transmitted and returned from the host vehicle 10 and the radar waves transmitted from the surrounding vehicles based on frequency.

In an operation 1115, the controller 160 may recognize the surrounding vehicle.

The controller 160 may recognize the surrounding vehicle by merging the radar waves transmitted from the host vehicle 10 with the radar waves transmitted from the surrounding vehicle. When recognizing the surrounding vehicle, the controller 160 may recognize the location and speed of the surrounding vehicle.

In an operation 1117, the controller 160 may reflect in autonomous driving scenarios based on the recognized surrounding vehicle.

The controller 160 may recognize the location and speed of the surrounding vehicle and reflect the recognized information in a scenario in which the host vehicle 10 performs autonomous driving along with the surrounding map information of the host vehicle 10 obtained from the map storage unit 150. Accordingly, the controller 160 may warn or prevent a collision with the surrounding vehicle while the host vehicle 10 is performing autonomous driving.

As is apparent from the above, various embodiments of the present disclosure may recognize the surrounding vehicle by receiving radar waves transmitted from the surrounding vehicle. Accordingly, the angle at which the radar is detected is increased compared to the conventional manners, enabling more stable recognition of the surrounding vehicle, thereby improving the stability of autonomous driving.

In addition, various embodiments of the present disclosure may increase the accuracy of recognition of the surrounding vehicle by additionally using the radar waves transmitted by the surrounding vehicle, thereby improving the stability of autonomous driving.

Although embodiments of the present disclosure have been shown and described, it should be appreciated by those having ordinary skill in the art that changes may be made in these embodiments without departing from the principles and spirit of the present disclosure. The scope of the present disclosure is defined by the appended claims and their equivalents.

What is claimed is:

1. A vehicle, comprising:
at least one radar configured to:
transmit a radar wave and receive a first radar wave reflected back from a surrounding vehicle, and
receive a second radar wave transmitted from the surrounding vehicle; and
a controller configured to recognize the surrounding vehicle using the first radar wave and the second radar wave received via the at least one radar.

2. The vehicle of claim 1, wherein the controller is configured to recognize the surrounding vehicle by merging the first radar wave and the second radar wave.

3. The vehicle of claim 1, wherein the controller is configured to distinguish between the first radar wave and the second radar wave based on frequency.

4. The vehicle of claim 1, wherein the controller is configured to recognize the surrounding vehicle using information on a location and speed of the surrounding vehicle.

5. The vehicle of claim 1, wherein:
the at least one radar includes a plurality of radars, and
the plurality of radars are configured to receive one or both of the first radar wave and the second radar wave at different angular ranges.

6. The vehicle of claim 5, wherein the controller is further configured to control the plurality of radars to operate sequentially.

7. The vehicle of claim 1, further comprising a map storage unit including location information and map information.

8. The vehicle of claim 7, wherein the controller is configured to determine whether the vehicle is about to collide with the surrounding vehicle using the location information and the map information from the map storage unit and information on the surrounding vehicle.

9. A method of controlling a vehicle, the method comprising:
transmitting, by at least one radar, a radar wave and receiving a first radar wave reflected back from a surrounding vehicle;
receiving, by the at least one radar, a second radar wave transmitted from the surrounding vehicle; and
recognizing, by a controller, the surrounding vehicle using the first radar wave and the second radar wave received via the at least one radar.

10. The method of claim 9, wherein recognizing the surrounding vehicle includes recognizing the surrounding vehicle by merging the first radar wave and the second radar wave.

11. The method of claim 9, further comprising: distinguishing, by the controller, between the first radar wave and the second radar wave based on frequency.

12. The method of claim 9, wherein recognizing the surrounding vehicle includes recognizing the surrounding vehicle using information on a location and speed of the surrounding vehicle.

13. The method of claim 9, wherein:
the at least one radar include a plurality of radars, and
receiving one or both of the first radar wave and the second radar wave includes receiving the one or both of the first radar wave and the second radar wave at different angular ranges.

14. The method of claim 13, further comprising: controlling, by the controller, the plurality of radars to operate sequentially.

15. The method of claim 9, further comprising: determining, by the controller, whether the vehicle is about to collide with the surrounding vehicle using location information and map information from a map storage unit and information on the surrounding vehicle.
